(19) United States
(12) Patent Application Publication
(10) Pub. No.: US 2010/0193977 A1
(43) Pub. Date: Aug. 5, 2010

(54) OZONE WATER PRODUCTION APPARATUS

(75) Inventors: Hiroaki Yamamoto, Osaka-shi (JP); Takashi Minamihonoki, Osaka-shi (JP); Shinji Masuoka, Osaka-shi (JP); Yoshishige Ninomiya, Osaka-shi (JP)

Correspondence Address: EDWARDS ANGELL PALMER & DODGE LLP, P.O. BOX 55874, BOSTON, MA, 02205, US

(73) Assignee: Sharp Kabushiki Kaisha, Osaka-Shi (JP)

(21) Appl. No.: 12/676,098

(22) PCT Filed: Sep. 3, 2008
(86) PCT No.: PCT/JP2008/065901

§ 371 Date: Mar. 2, 2010

(30) Foreign Application Priority Data
Sep. 3, 2007 (JP) 2007-228256

(51) Int. Cl. B01F 3/04; B01F 1/00

(52) U.S. Cl. 261/151; 261/30

(57) ABSTRACT

The invention relates to an ozone water production apparatus capable of producing ozone water with a highly versatile and simpler configuration and further producing ozone water having a higher concentration with decomposition by heat suppressed. O₂ gas and N₂ gas are introduced into an ozonizer (2), and ozone is generated in the ozonizer (2). The generated ozone is mixed with supplied water, and thereafter the mixture is introduced into a circulation pump (4) to dissolve ozone in water. A pipe from the ozonizer (2) is connected to a water pipe connected to the circulation pump (4) using a T-shaped union joint to mix water and the generated ozone gas. Further, the ozone water is heated to a predetermined temperature by a heat exchanger (5a) using hot water as a heat medium.

### TECHNICAL FIELD

The present invention relates to an apparatus for producing ozone water used for cleaning components in an industry in general and for a disinfecting treatment of medical or food-related instruments and food.

### BACKGROUND ART

It has been examined to apply ozone water to a cleaning treatment and a disinfecting treatment of components and the like. Among them, especially in a field of cleaning components, there is no problem of environmental contamination and safety in cleaning with ozone water compared to a conventional cleaning method using a medical agent, but there is a problem that it requires a long time to decompose and remove contamination.

In order to solve the problem, it is necessary to further increase a concentration and a temperature of ozone water. Considering this based on reaction kinetics, a reaction constant needs to be increased in decomposition of a contaminant. Assuming that the reaction constant k in decomposition follows the Arrhenius equation as shown by Equation (1), a frequency factor A and a temperature T may be heightened in order to increase the value of k.

[Equation 1]

k=A·exp(−Eₐ/RT) (1)

In the equation, Eₐ denotes activation energy, and R denotes a gas constant. Increase of the value of the frequency factor A is realizable by increasing an ozone concentration of ozone water.

In this manner, the Arrhenius equation also shows that it is necessary to further increase a concentration and a temperature of ozone water.

In an ozone water cleaning system described in Japanese Unexamined Patent Publication JP-A 2003-260342, a heater for raising a temperature of ozone water is provided in an ozone water supply line between a cleaning tank and an ozone water manufacturing apparatus so that a temperature of ozone water is increased.

In an ozone mixing apparatus described in Japanese Unexamined Patent Publication JP-A 2000-58496, sprayed ultrapure water is introduced into a gap formed between an ozone gas supply tube and a tapered channel in an ejector to promote mixing of ozone gas and ultrapure water so that a concentration of ozone water is increased.

Improvement to a specific mixer such as an ejector not only requires an advanced technique but also leads to a cost increase even when a high-performance mixer is able to be developed. Accordingly, it is desirable to increase a concentration of ozone water not with a specific configuration but with a highly versatile and simpler configuration.

In addition, there are mainly two types of methods for increasing a temperature of ozone water. A first method is for increasing a temperature of raw water to a use temperature in advance and thereafter mixing ozone gas therewith. A second method is for mixing water at a room temperature with ozone gas to produce ozone water and thereafter heating the ozone water to increase a temperature to a use temperature.

In the first method, ozone water having a high concentration is hardly obtained due to a high temperature of raw water. Thus, the second method is generally applied in many cases. A problem in the second method is decomposition of ozone molecules in a solution caused by supply of excess heat energy to ozone water. For example, when ozone water is directly heated by a sheathed heater, large heat energy is locally supplied to the ozone water and excess heat energy decomposes ozone molecules in a solution into oxygen. Thus, even when ozone water having a high concentration is heated, the concentration is significantly reduced. For this reason, ozone water needs to be heated, with self-decomposition of ozone molecules in a solution minimized, to a required temperature in a short time.

### DISCLOSURE OF INVENTION

An object of the invention is to provide an ozone water production apparatus capable of producing ozone water with a highly versatile and simpler configuration and further producing ozone water having a higher concentration with decomposition by heat suppressed.

The invention provides an ozone water production apparatus for producing ozone water in which ozone gas is dissolved by mixing supplied water and ozone gas, the ozone water production apparatus comprising a positive-displacement pump, ozone gas being dissolved in water by circulating water by the positive-displacement pump and mixing ozone with circulating water.

Furthermore, in the invention, it is preferable that an amount of circulation liquid by the positive-displacement pump is four times or more a discharge flow rate of produced ozone water.

Furthermore, in the invention, it is preferable that the ozone water production apparatus comprises a circulation tank for temporarily storing circulation liquid, and a pressure in the circulation tank is held constant at a pressure higher than a normal pressure.

Furthermore, in the invention, it is preferable that the ozone water production apparatus comprises a heating section for heating a part of circulating ozone water, and a concentration of circulating ozone is made lower than its saturation solubility at a room temperature and higher than its saturation solubility at a predetermined high temperature that is higher than a room temperature, and

supersaturated ozone water having a higher ozone concentration than the saturation solubility at a high temperature is produced by heating part of circulating ozone water by the heating section.

Furthermore, in the invention, it is preferable that the heating section is a heat exchanger using hot water as a heat medium.

Furthermore, in the invention, it is preferable that the heating section raises a temperature of ozone water to a predetermined temperature in a short time of 8 to 10 seconds.

### BRIEF DESCRIPTION OF DRAWINGS

Other and further objects, features, and advantages of the invention will be more explicit from the following detailed description taken with reference to the drawings wherein:

FIG. 1 is a schematic view showing a configuration of an ozone water production apparatus according to an embodiment of the invention;

FIG. 2 is a graph showing a relation between a concentration of ozone water and a circulation amount;

FIG. 3 is a graph showing a relation between a concentration of ozone water and a liquid temperature; and

FIG. 4 is a graph showing a relation between a concentration of ozone water after heating (50° C.) and a heating time.

### BEST MODES FOR CARRYING OUT THE INVENTION

Now referring to the drawings, preferred embodiments of the invention are described below.

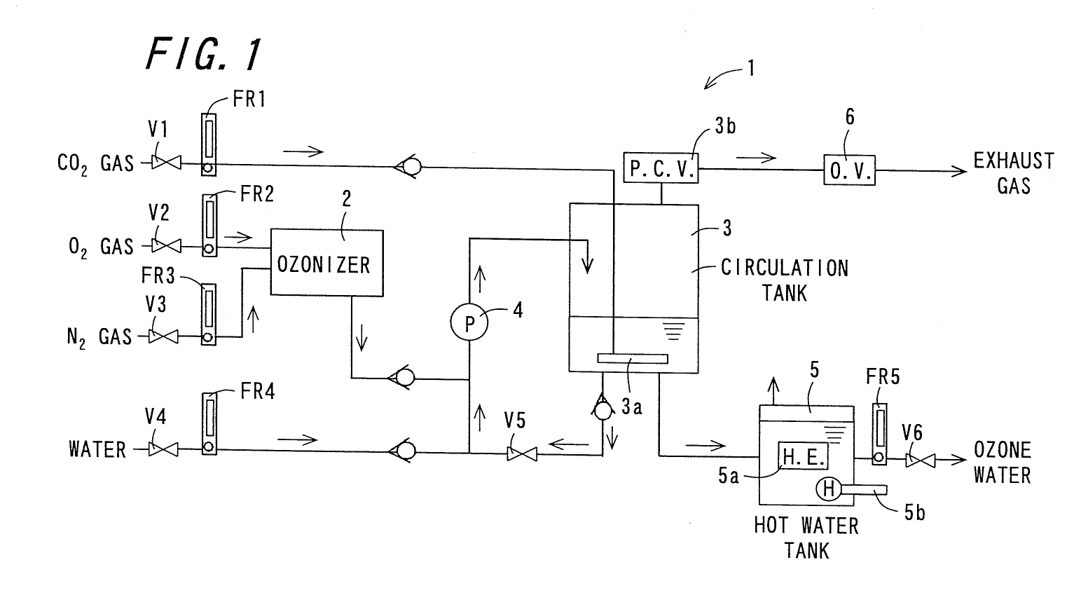

FIG. 1 is a schematic view showing a configuration of an ozone water production apparatus 1 according to an embodiment of the invention. The ozone water production apparatus 1 includes an ozonizer (ozone producing device) 2, a circulation tank 3, a circulation pump 4, and a hot water tank for heat exchange 5, and further includes introducing pipes from respective supply sources of CO₂ (carbon dioxide) gas, O₂ (oxygen) gas, N₂ (nitrogen) gas, and water, valves provided in each of the pipes, flow meters, and the like.

The ozone water production apparatus 1 mixes ozone gas and water using the circulation pump 4, without being provided with a mixer, to dissolve ozone in water.

CO₂ gas is introduced to a bubbler 3a of the circulation tank 3 and supplied to ozone water stored in the circulation tank 3. By supplying CO₂ gas to ozone water, a pH of ozone water is adjusted to a desired pH. The pH of ozone water is almost 4 to 6, even though an optimum value thereof varies depending on use purpose of ozone water.

In the supply amount of CO₂ gas, a flow rate is adjusted by opening and closing of a valve V1 provided between the supply source and the bubbler 3a and a flow meter FR1. For a supply of CO₂ gas, for example, a supply pressure is 0.31 to 0.40 MPa and a flow rate is 100 to 1000 mL·min⁻¹.

O₂ gas and N₂ gas are introduced to the ozonizer 2 and the ozonizer 2 generates ozone. The generated ozone is mixed with supplied water and then introduced to the circulation pump 4. A pipe from the ozonizer 2 is connected to a water pipe connected to the circulation pump 4 using a T-shaped union joint to mix water and the generated ozone gas.

In the supply amount of O₂ gas, a flow rate is adjusted by opening and closing of a valve V2 provided between the supply source and the ozonizer 2 and a flow meter FR2, and in the supply amount of N₂ gas, a flow rate is adjusted by opening and closing of a valve V3 provided between the supply source and the ozonizer 2, and a flow meter FR3. For a supply of O₂ gas, for example, a supply pressure is 0.31 to 0.40 MPa and a flow rate is 1 to 10 L·min⁻¹. For a supply of N₂ gas, for example, a supply pressure is 0.31 to 0.40 MPa and a flow rate is 10 to 100 mL min⁻¹.

In the supply amount of water, a flow rate is adjusted by opening and closing of a valve V4 provided between the supply source and the circulation pump 4, and a flow meter FR4.

Water and ozone gas that have been mixed in advance are further mixed inside the circulation pump 4 to dissolve ozone gas in water. Ozone water is discharged to the circulation tank 3 by the circulation pump 4 and mixed with CO₂ gas as described above.

In this case, the circulation pump 4 also needs to have a mixing function, and thus, it is preferable that a positive-displacement pump such as a bellows pump or a diaphragm pump is used. When a volute pump or the like is used as the circulation pump 4, a speed of pressure fluctuation of water is high and ozone molecules are decomposed into oxygen by mechanical energy. In addition, when the amount of ozone gas to be supplied is increased, it is impossible to normally perform liquid feeding, which is not preferable. Considering a mixing function, the circulation pump 4 preferably has a capability of about 0.5 to 5 L/cycle as discharge amount.

A part of ozone water stored in the circulation tank 3 is returned to the water pipe and mixed with the generated ozone and thereafter introduced to the circulation pump 4. Ozone water is discharged from the circulation tank 3, mixed with new water and ozone gas, introduced to the circulation pump 4, and circulated in a circulation line returning to the circulation tank 3. The discharge amount from the circulation tank 3 is adjusted by opening and closing of a valve V5 provided between the circulation tank 3 and a connecting portion to the water pipe.

The circulation tank 3 is configured to store 2 to 20 L (liters) of ozone water at all times, in which it is preferable that the amount of circulation liquid is four times or more a discharge flow rate (use amount) of 1 to 10 L·min⁻¹ from the circulation tank 3, that is, 4 to 40 L·min⁻¹ or more.

The ozone water discharged from the circulation tank 3 is introduced to a heat exchanger 5a provided inside the hot water tank 5 and heated to a predetermined temperature. Hot water is stored as a heat exchange medium in the hot water tank 5 and heated to an appropriate temperature by a heater 5b.

In direct heating of ozone water by a sheathed heater or the like, large heat energy is locally applied and the excess heat energy decomposes ozone molecules in the ozone water into oxygen, and therefore heating by a heat exchanger is preferable. The heat exchanger 5a is preferably a heat transfer tube, for example, one using PFA or titanium. PFA is a copolymer of tetrafluoroethylene (TFE) and perfluoroalkoxy ethylene.

The ozone water heated to a predetermined temperature by the heat exchanger 5a is supplied to a cleaning apparatus and the like in subsequent stages.

A volume of the circulation tank 3 is 5 to 50 L and a pressure in the circulation tank is adjusted with a pressure control valve 3b to, for example, 0.30 to 0.39 MPa.

In addition, the circulation tank 3 is also installed for gas-liquid separation in ozone water. The excess ozone gas that is not dissolved in ozone water is subjected to gas-liquid separation from a solution in the circulation tank 3. Not only the excess ozone gas but also oxygen gas into which ozone gas is self-decomposed with time are discharged via the pressure control valve 3b described above. Note that, ozone gas in exhaust gas is decomposed by an ozone decomposer 6 before being discharged to the atmosphere.

Description will be given below for an example.

In this example, ozone water having a high concentration (about 140 mg·L⁻¹), whose liquid temperature is 50° C., was produced using a bellows pump (PE-80MA manufactured by Nippon Pillar Packing Co., Ltd.) as the circulation pump 4 and a self-made PFA heat exchanger (which is made by bundling five 15-meter PFA tubes of ¼ inch in diameter) or a titanium heat exchanger (TBHE-TiM-21AV manufactured by Tokyo Braze Co., Ltd.) as the heat exchanger 5a.

The valves V1 to V4 were opened to supply water, oxygen gas, nitrogen gas, and carbon dioxide gas, respectively. The supply pressure of oxygen gas and nitrogen gas at this time was 0.32 MPa or more and flow rates were 6 L·min⁻¹ and 50 L·min⁻¹, respectively. When the ozonizer 2 (GR-RG manufactured by Sumitomo Precision Products Co., Ltd.) was operated, ozone gas having a pressure of 0.32 MPa and a flow rate of about 6 L·min⁻¹ was discharged in a concentration of 290 g·Nm⁻³. While continuing this operation, water was supplied with the same flow rate of 5 L·min⁻¹ as the discharge flow rate of ozone water. At this time, a liquid level in the circulation tank 3 was adjusted with the flow meter FR5 so that 10 L of water was stored in the tank at all times.

Next, when the circulation pump 4 is operated, ozone gas was sucked in a circulation line with water to generate ozone water. At this time, carbon dioxide was supplied to the bubbler 3a such that a pH of ozone water was 5. The supply amount of CO₂ was controlled with the flow meter FR1. By these operations, ozone water having a concentration of 161 mg·L⁻¹ at a room temperature was produced.

The circulation amount of water in this case was 22 L·min⁻¹, which significantly affects the concentration of ozone water. For this reason, the circulation amount was set based on relation data between the concentration of ozone water and the circulation amount that had been measured in advance.

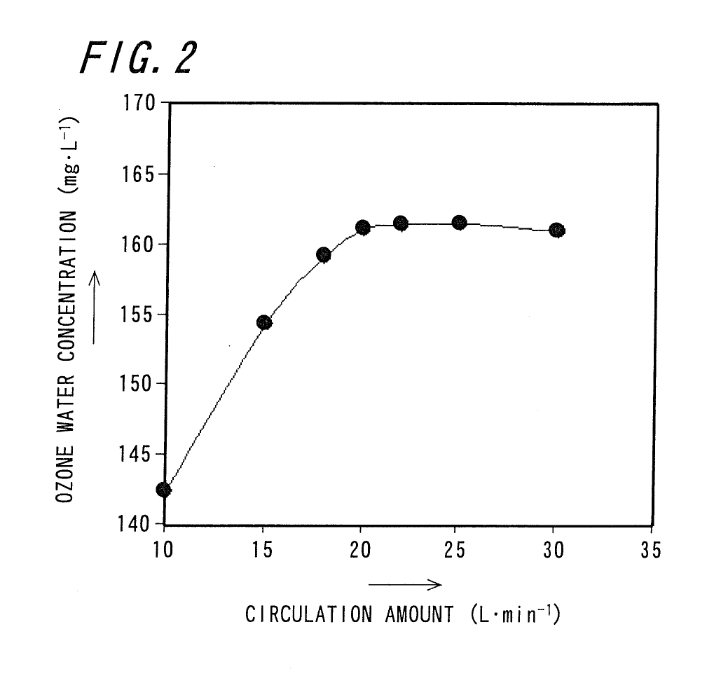

FIG. 2 is a graph showing a relation between a concentration of ozone water and a circulation amount. The circulation amount (L·min⁻¹) is shown by a horizontal axis and the concentration of ozone water (mg·L⁻¹) is shown by a vertical axis.

The graph shows that the concentration of ozone water tends to be increased when the circulation amount is increased. When the circulation amount exceeds about 20 L·min⁻¹, however, the concentration of ozone water substantially becomes constant at about 160 mg·L⁻¹. This flow rate corresponds to four times the discharge flow rate of ozone water (5 L·min⁻¹). Thus, ozone water was produced with the circulation amount of 22 L·min⁻¹ which is 10% greater than 20 L·min⁻¹ in order to produce ozone water having a stable concentration.

Since a saturation solubility of ozone at 25° C. was 219 mg·L⁻¹, it was found that mixing was performed with the concentration of generated ozone water being slightly lower than the saturation solubility and higher than the saturation solubility at a higher temperature (for example, at 50° C. with the saturation solubility of 126 mg·L⁻¹).

Note that an estimated value of the saturation solubility was obtained as follows.

When the molar fraction of a soluble component, especially in a solution, is small in dissolution of gas to liquid, the molar fraction is known to be proportional to a partial pressure of the component in gas. A proportional constant thereof is defined by Equation (2) as the Henry's constant H.

[Equation 2]

H=p/x (2)

In this equation, p (atm) denotes a partial pressure of ozone in gas, and x denotes a molar fraction of ozone in liquid.

Equation (2) was transformed to obtain the value of x, and thereafter the value of x was converted into the mg·L⁻¹ unit to calculate the saturation solubility. In addition, an approximate value obtained by using the Roth-Sullivan equation by which the effect of pH and temperature could be evaluated was adopted even though a lot of data of the value of the constant H used for the calculation had been made public. The Roth-Sullivan equation is shown below as Equation (3).

[Equation 3]

H=3.842×10⁷[OH⁻]^{0.035 exp(-2428/T)} (3)

In this equation, [OH⁻] denotes a concentration of hydroxide ion, and T denotes a liquid temperature.

Next, the produced ozone water at 25° C. was heated to 50° C. while supplying heat energy using the heat exchanger 5a. A heat exchange area of the heat exchanger 5a used at this time, a residence time of ozone water, and a temperature of hot water were 0.87 m², 10 seconds, and 78° C., respectively. Note that, when the titanium heat exchanger was used, for example, they were 0.30 m², 8 seconds, and 62° C.

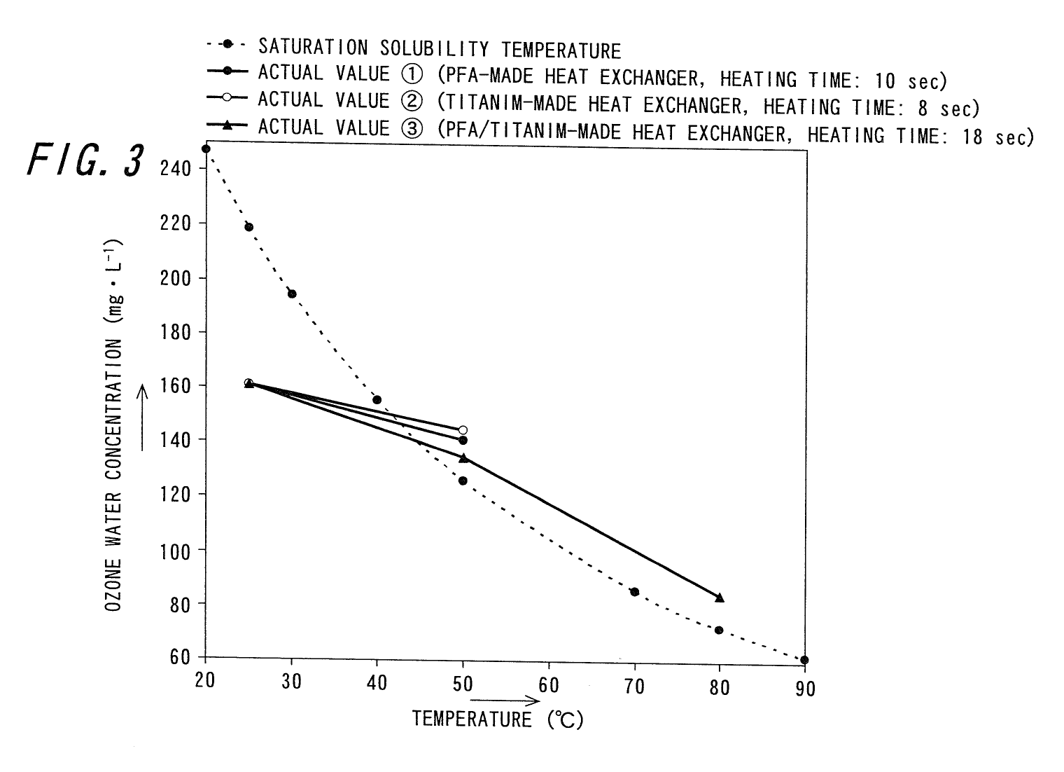

The graph of FIG. 3 shows the results of measuring a concentration of ozone water after heating.

Temperature (° C.) is shown by a horizontal axis and the concentration of ozone water (mg·L⁻¹) is shown by a vertical axis.

When the PFA heat exchanger was used, the concentration of ozone water at a liquid temperature of 50° C. was 141 mg·L⁻¹. In addition, when the titanium heat exchanger was used, the concentration of ozone water at a liquid temperature of 50° C. was 145 mg·L⁻¹. Since the saturation solubility of ozone water at 50° C. was 126 mg·L⁻¹, it was found that the produced ozone water was oversaturated ozone water having a sufficiently higher concentration than the saturation solubility.

Now, in order to confirm a relation between ozone water and heating time at a high temperature, the PFA heat exchanger and the titanium heat exchanger were connected in series and a temperature of hot water was set to 60° C. to produce ozone water at 50° C. As a result, the concentration of ozone water showed 135 mg·L⁻¹. The heating time at this time was 18 seconds. The result thereof was added in FIG. 3.

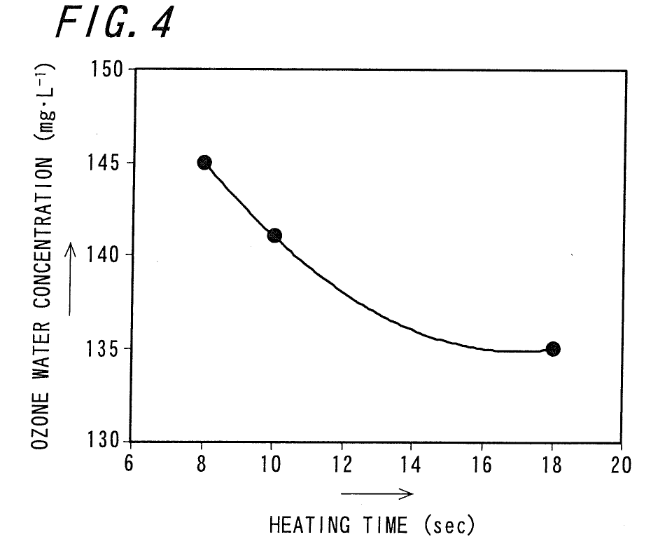

It is more preferable that the heating time for raising a temperature of ozone water to a required temperature is short. This can be seen from a relation between the concentration of ozone water after heating and the heating time shown in the graph of FIG. 4.

The heating time (sec) is shown by the horizontal axis and the concentration of ozone water (mg·L⁻¹) is shown by the vertical axis.

The concentration of ozone water after heating was measured by changing a time taken to raise a temperature of ozone water having the concentration of about 160 mg·L⁻¹ at 25° C., to 50° C. The time to raise a temperature to 50° C. was varied by changing a type of the heat exchanger.

As can be seen from the graph, since a decrease in the concentration of ozone water can be reduced as the heating time was shorter, it is preferable to raise a temperature to a targeted liquid temperature in as short a time as possible. Specifically, it became evident that the concentration of ozone water at 50° C. became higher when the heating time of ozone water was short, i.e., about 8 seconds or 10 seconds, compared to the case of 18 seconds. Thus, it can be seen that shorter time, i.e., about 8 to 10 seconds, of the heating time of ozone water led to better results.

Furthermore, for reference, ozone water at 80° C. was produced by an apparatus in which the PFA heat exchanger and the titanium heat exchanger were connected in series, a temperature of hot water being set to 92° C. Then, the concentration of ozone water at 80° C. showed 85 mg·L⁻¹ and the value thereof was further added in FIG. 3. As is clear from the results, it was confirmed that supersaturated ozone water having a sufficiently higher concentration than the saturation solubility (73 mg·L⁻¹) could be obtained at 80° C. as well.

Finally, since supersaturated ozone water is in a thermodynamically nonequilibrium state, the concentration of ozone water approaches the saturation solubility with time. Therefore, when supersaturated ozone water is used, it is preferable that a heat exchanger is installed in an immediate vicinity of a point of use.

The invention may be embodied in other specific forms without departing from the spirit or essential characteristics thereof. The present embodiments are therefore to be considered in all respects as illustrative and not restrictive, the scope of the invention being indicated by the appended claims rather than by the foregoing description and all changes which come within the meaning and the range of equivalency of the claims are therefore intended to be embraced therein.

### INDUSTRIAL APPLICABILITY

According to the invention, water is circulated by a positive-displacement pump and ozone is mixed with circulating water to thereby dissolve ozone gas in water.

With this configuration, it is possible to produce ozone water with a simpler configuration since a highly versatile positive-displacement pump such as a bellows pump or a diaphragm pump is used even without having a specific configuration such as an ejector or a dissolution membrane.

According to the invention, an amount of circulation liquid by the positive-displacement pump is four times or more a discharge flow rate of produced ozone water.

When a relation between the concentration of ozone water and the amount of circulation liquid was examined, it was found that the concentration of ozone water tended to be increased when the amount of circulation liquid was increased. Since the concentration of ozone becomes the highest when the amount of circulation liquid is four times or more the discharge flow rate, such a setting is preferable.

According to the invention, a circulation tank for temporarily storing circulation liquid is included, and a pressure in the circulation tank is held constant at a pressure higher than a normal pressure.

This makes it possible to make the concentration of ozone dissolved in water higher.

According to the invention, a heating section for heating a part of circulating ozone water is included, and a concentration of circulating ozone is a concentration that is lower than a saturation solubility at a room temperature and higher than a saturation solubility at a predetermined high temperature that is higher than a room temperature. Further, by heating the heating section, it is possible to produce supersaturated ozone water having a higher ozone concentration than the saturation solubility at the high temperature.

According to the invention, the heating section is a heat exchanger using hot water as a heat medium.

When ozone water is directly heated by a sheathed heater or the like, excess heat energy decomposes ozone molecules into oxygen, and therefore, it is possible to suppress decomposition into oxygen and produce ozone water having a higher concentration by heating the ozone water with a heat exchanger.

According to the invention, the heating section raises a temperature of ozone water to a predetermined temperature in a short time of 8 to 10 seconds.

When the temperature is raised from a room temperature to a predetermined temperature, it was found that the concentration of ozone was reduced as a heating time became longer. Therefore, it is possible to produce ozone water having a higher concentration by raising a temperature to a predetermined temperature in a shorter time.

1. An ozone water production apparatus for producing ozone water in which ozone gas is dissolved by mixing supplied water and ozone gas, the ozone water production apparatus comprising a positive-displacement pump, ozone gas being dissolved in water by circulating water by the positive-displacement pump and mixing ozone with circulating water.

2. The ozone water production apparatus of claim 1, wherein an amount of circulation liquid by the positive-displacement pump is four times or more a discharge flow rate of produced ozone water.

3. The ozone water production apparatus of claim 1 or 2, comprising a circulation tank for temporarily storing circulation liquid,
wherein a pressure in the circulation tank is held constant at a pressure higher than a normal pressure.

4. The ozone water production apparatus of any one of claims 1 to 3, comprising a heating section for heating a part of circulating ozone water,
wherein a concentration of circulating ozone is made lower than its saturation solubility at a room temperature and higher than its saturation solubility at a predetermined high temperature that is higher than a room temperature, and
supersaturated ozone water having a higher ozone concentration than the saturation solubility at a high temperature is produced by heating part of circulating ozone water by the heating section.

5. The ozone water production apparatus of claim 4, wherein the heating section is a heat exchanger using hot water as a heat medium.

6. The ozone water production apparatus of claim 4 or 5, wherein the heating section raises a temperature of ozone water to a predetermined temperature in a short time of 8 to 10 seconds.
